(19) United States
(12) Patent Application Publication
(10) Pub. No.: US 2020/0161663 A1
(43) Pub. Date: May 21, 2020

(54) Honeycomb Electrode Secondary Battery

(71) Applicant: Danilo Patricio Cabrera, Farmingdale, NY (US)

(72) Inventor: Danilo Patricio Cabrera, Farmingdale, NY (US)

(21) Appl. No.: 16/752,791

(22) Filed: Jan. 27, 2020

Related U.S. Application Data
(60) Provisional application No. 62/798,985, filed on Jan. 30, 2019.

(51) Int. Cl. H01M 4/72; H01M 10/0525; H01M 10/0562

(52) U.S. Cl. CPC H01M 4/72; H01M 10/0562; H01M 10/0525

(57) ABSTRACT

A secondary battery includes a honeycomb first electrode, a fluid second electrode, and a solid electrolyte. The solid electrolyte has ionic conductivity and insulates the honeycomb first electrode from the fluid second electrode. The honeycomb structure of the secondary battery is open-ended and allows for the free flow of the fluid second electrode.

### CROSS-REFERENCE TO RELATED APPLICATIONS

This application claims the benefit of U.S. Provisional Application No. 62/798,985, filed on Jan. 30, 2019, with the U.S. Patent and Trademark Office, the disclosure of which is incorporated herein in its entirety by reference.

### FIELD OF THE INVENTION

Embodiments of the disclosure relate to a secondary battery including a honeycomb electrode.

### BACKGROUND

Nowadays, secondary batteries are widely used in a myriad of devices such as cell phones, portable computers, robots, electric vehicles, and more recently in power storage for renewable energy such as solar and wind power. A secondary battery comprises one or more secondary battery cells and each secondary battery cell contains no more than two electrodes. A secondary battery refers to a battery capable of charging and discharging.

Modern secondary batteries, despite advances in the science, remain very limited in their performance, notably; the slow battery rate, their limited energy density, excessive heat generation, and restricted heat dissipation. The energy density is related to the capacity of the battery and the battery rate is related to the charging time of a secondary battery. Secondary battery performance strongly depends on the geometric structure and size of the electrodes.

A typical secondary battery comprises a positive electrode, a negative electrode, and a separator layer. These layers are either rolled or stacked together to form the secondary battery. The separator layer typically consists of a porous film separator enveloped in either a liquid electrolyte or a gel polymer electrolyte.

U.S. Pat. No. 10,411,242 reveals a rolled secondary battery configuration typical of the industry that includes a first electrode, a separator, and a second electrode; sequentially stacked and wound.

U.S. Pat. No. 10,270,121 reveals a stacked secondary battery configuration typical of the industry in which a positive electrode and a negative electrode are stacked alternately with a separator interposed therebetween.

U.S. Pat. No. 10,522,818 reveals a secondary battery not typical of the industry with a “three-dimensional” electrode structure with columns supporting the various “plates” for improved structural stability. Their invention, does not have a honeycomb electrode.

U.S. Pat. No. 5,567,544 reveals a stacked secondary battery shaped in the form of a lightweight honeycomb structural panel. Their invention is an approach to create a structure from a battery. Their invention, does not have a honeycomb electrode.

U.S. Pat. No. 5,916,706 reveals a secondary battery comprising a honeycomb structure ceramic separator. Their invention, does not have a honeycomb electrode.

U.S. Pat. Application No. 20190312256 reveals a “cable type” secondary battery comprising a plurality of “columnar body” secondary battery cells bundled together in a parallel honeycomb arrangement with two current collectors at both ends. In another embodiment of their invention, the separator is a honeycomb structure. Their invention, does not have a honeycomb electrode.

Some examples of prior art, have utilized honeycomb structures only as separators and/or for structural purposes, not as a honeycomb electrode.

Existing art, concerning industry standard secondary batteries, consists of stacked or rolled secondary batteries. Two restrictions with this approach are the limited electrode surface areas needed for electrochemical reactions and the lack of an internal thermal management feature which hinders safe operation during heavy-duty applications.

### SUMMARY OF THE INVENTION

Embodiments of the present invention relate to a honeycomb electrode secondary battery with vast electrode surface areas.

Embodiments of the present invention relate to a honeycomb electrode secondary battery with an internal thermal management feature.

Embodiments of the present invention relate to a honeycomb electrode secondary battery with enhanced performance, including; improved battery rate, increased capacity, and better energy density.

Embodiments of the present invention relate to a honeycomb electrode secondary battery that employs a solid electrolyte and has improved structural strength.

The present invention provides a honeycomb electrode secondary battery that contains a honeycomb first electrode, a fluid second electrode, and a solid electrolyte. The solid electrolyte has ionic conductivity and insulates the honeycomb first electrode from the fluid second electrode. The honeycomb structure of the secondary battery is open-ended and allows for the free flow of the fluid second electrode. The honeycomb electrode secondary battery provides enhanced secondary battery performance, a thermal management feature, and a chemical byproduct purging feature.

In an exemplary embodiment, the present secondary battery has a honeycomb anode, a fluid cathode, and a solid electrolyte. The honeycomb anode is composed of an anode honeycomb current collector and an anode active material layer. The present secondary battery also comprises a fluid cathode and a solid electrolyte. The fluid cathode is composed of two current collector covers and a fluid cathode active material. The cathode current collector covers together with the honeycomb anode contain the fluid cathode active material. The solid electrolyte has ionic conductivity and insulates the honeycomb anode from the fluid cathode. The channels within the honeycomb structure are open-ended and extend the length of the honeycomb structure. The honeycomb structure of the present secondary battery provides enhanced secondary battery performance by providing vast electrode surface areas for electrochemical reactions and allowing for the free flow of the fluid cathode active material through the honeycomb structure for thermal management.

In another exemplary embodiment, the present secondary battery has a honeycomb anode, a fluid cathode, and a solid electrolyte. The honeycomb anode is composed of an anode active material and acts as the current collector for itself. The fluid cathode is composed of a cathode substrate layer and a fluid cathode active material. The solid electrolyte has ionic conductivity and insulates the honeycomb anode from the fluid cathode. The channels within the honeycomb structure are open-ended and extend the length of the honeycomb structure. The honeycomb structure of the present secondary battery provides enhanced secondary battery performance by providing vast electrode areas for electrochemical reactions and allowing for the free flow of the fluid cathode active material through the honeycomb structure for thermal management, fluid cathode active material replenishment, and chemical byproduct purging.

### BRIEF DESCRIPTION OF THE DRAWINGS

The invention is illustrated in the appended drawings, wherein like parts are identified by like numbers:

FIG. 1 presents a perspective view of an embodiment of the present honeycomb electrode secondary battery in liquid metal electrode (“LME”) form.

FIG. 2 is a cross-sectional view taken along the line IV-IV in FIG. 1.

FIG. 3 provides a cross-sectional view taken along the line VI-VI in FIG. 1.

FIG. 4 presents an elevational cross-sectional view of a practical embodiment of the present invention incorporating the honeycomb electrode secondary battery embodiment illustrated in FIG. 3.

FIG. 5 presents a perspective view of an embodiment of the present honeycomb electrode secondary battery in lithium-oxygen form.

FIG. 6 is a cross-sectional view taken along the line IX-IX in FIG. 5.

FIG. 7 provides a cross-sectional view taken along the line XI-XI in FIG. 5.

### DETAILED DESCRIPTION OF THE INVENTION

The advantages, features, and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments.

The term “honeycomb” has come to mean cellular, extruded, bodies regardless of honeycomb cell shape. Thus, the honeycomb electrode channels are not restricted to the conventional hexagonal shape, but may have any desired cross-sectional geometry such as oval, round, rectangular, square, and triangular.

Important parameters of battery performance include battery rate, energy density, heat generation and heat dissipation. The energy density is related to the capacity of a secondary battery and the battery rate is related to the charging time of a secondary battery. Secondary battery performance does not only depend on the material properties of the electrodes and electrolyte, but also, strongly depends on the geometric structure and size of the electrodes. The bigger the electrode surface areas are, the better the overall performance can be. Electrochemical reaction and ion exchange processes in a secondary battery benefit from vast electrode surface areas.

The invention is based on three functional concepts for using a honeycomb electrode secondary battery. The first concept involves providing vast electrode surface areas where electrochemical reactions occur for enhanced secondary battery performance. The second concept is the ability of a fluid electrode to flow through the honeycomb electrode structure for thermal management. The third concept is the ability to purge chemical byproducts that may be produced in the case of the lithium-oxygen battery.

Honeycomb structures similar to the one of the honeycomb electrode secondary battery of the present invention possess abundant internal surface areas for electrochemical reactions to take place. An example of a honeycomb structure is the catalytic converter in a car which has an internal surface area equivalent to that of a football field, such a large internal surface area is not only achieved by the multitude of the walls within the channels of the honeycomb structure but also by the surface roughness and atomic scale roughness on the surface of the walls.

The honeycomb channel size can be defined in terms of honeycomb channels per unit area and is dependent on the requirements of the battery application involved. It is desirable for the present invention that the number of honeycomb channels per unit area is as high as possible as it relates to the vastness of electrode surface areas, for ease of presentation purposes only sixteen channels will be illustrated in the various embodiments. In general wall thickness decreases as the number of honeycomb channels per unit area increases, therefore important factors to consider are the structural integrity, chemical stability, and electrical properties of the layers within the honeycomb electrode secondary battery which together account for the thickness of the walls of the channels within the honeycomb structure. An extremely thin solid electrolyte layer has significant electrochemical advantages.

The separator part of a secondary battery typically consists of a porous film separator enveloped in either a liquid electrolyte or a gel polymer electrolyte. A solid electrolyte voids the need for a porous film separator. A solid electrolyte is a fundamental part of the present invention as typical liquid or polymer gel electrolytes would not work. A solid electrolyte must be in close ionic contact with both electrodes, have good ionic conductivity, and insulate the first electrode from the second electrode.

A secondary battery comprises one or more secondary battery cells and each secondary battery cell contains no more than two electrodes. A secondary battery refers to a battery capable of charging and discharging. A secondary battery exists both as a galvanic and an electrolytic battery. A galvanic battery converts chemical energy into electrical energy during discharge and an electrolytic battery converts electrical energy into chemical energy during recharge, in effect the same secondary battery can be referred to as both a galvanic battery and an electrolytic battery.

An electrode is typically composed of a current collector and an active material. A secondary battery cell contains two electrodes; the first electrode and the second electrode. These can be referred to as the positive electrode and the negative electrode, or as the cathode and anode respectively during discharge. In a galvanic battery, the anode is considered negative and the cathode is considered positive. This seems reasonable as the anode is the source of electrons and cathode is where the electrons flow. However, in an electrolytic battery, the anode is taken to be positive while the cathode is negative.

The positive electrode contains a positive electrode electrochemical material that undergoes electrochemical reduction during battery discharge and electrochemical oxidation during battery charge. The negative electrode contains a negative electrode electrochemical material that undergoes electrochemical oxidation during battery discharge and electrochemical reduction during battery charge.

The present invention does not focus on any specific electrochemical materials, but rather it focuses on enhancing secondary battery performance by providing vast electrode surface areas where electrochemical reactions take place. Many electrochemical materials otherwise known as active materials are known in the art, which can be solids or fluids. Fluids include liquids and gases, this is important since lithium-oxygen batteries such as lithium-air and lithium-water batteries can also benefit from a honeycomb electrode structure.

The honeycomb first electrode and the fluid second electrode may alternatingly be the anode and the cathode respectively, this distinction does not affect the scope of the present invention, although it is important to note that the electrode polarities and roles can alternate depending upon the electrochemical reaction taking place and their chemical composition. The honeycomb first electrode may be a singular object or it may be composed of additional electrode layers. The fluid second electrode may be a singular fluid or it may be part fluid additionally composed of electrode parts such as current collectors or substrate layers.

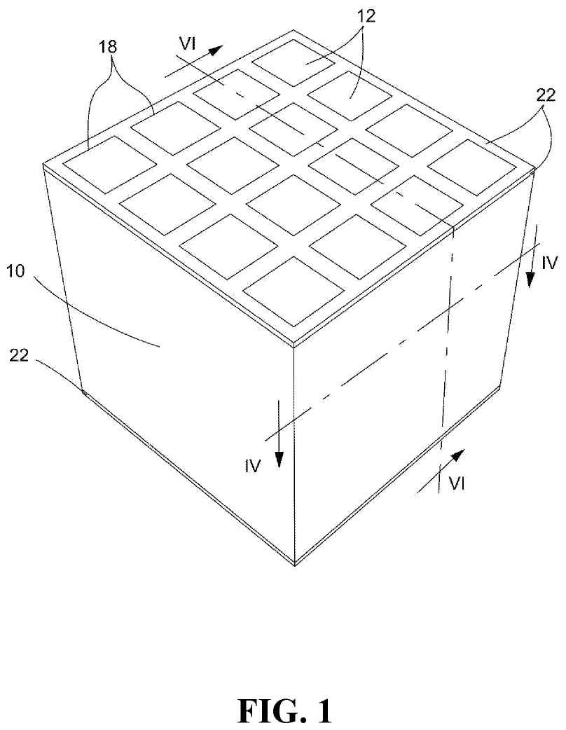

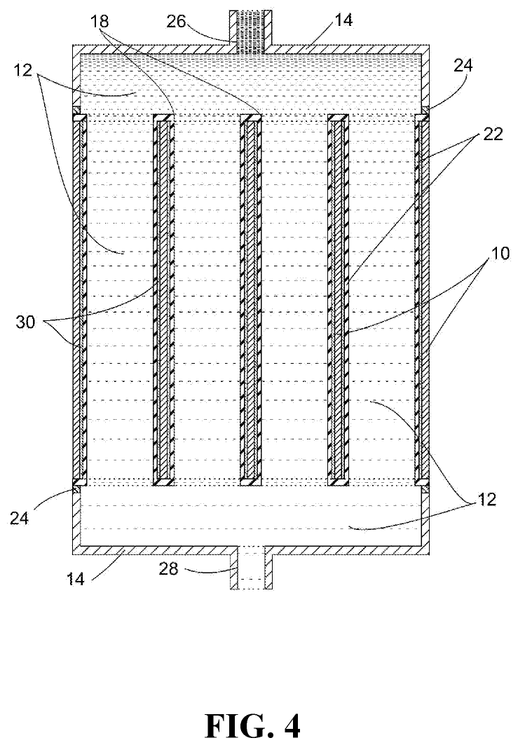

FIG. 1 is a perspective view of a non-limiting embodiment of the present honeycomb electrode secondary battery in liquid metal electrode (“LME”) form, the anode honeycomb current collector 10 together with the solid electrolyte 22 define a plurality of channels 18 that are open-ended and extend from one end to the other of the honeycomb structure. The fluid cathode active material 12 fills the channels 18. FIG. 4 illustrates the integrality and continuity of the fluid cathode active material 12 needed for a practical secondary battery.

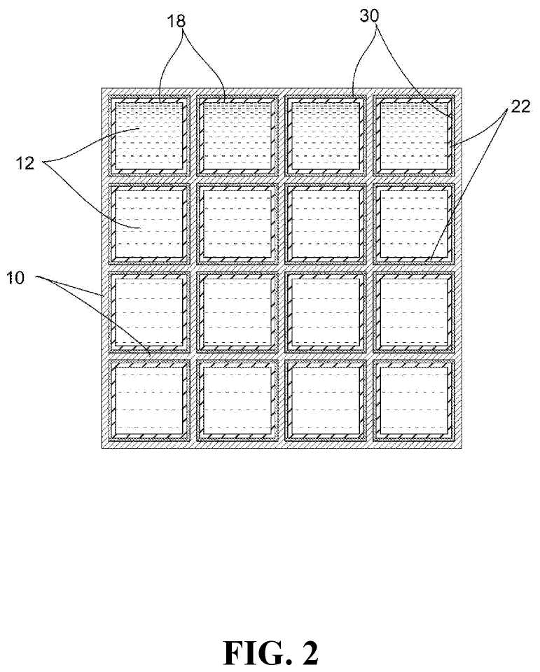

FIG. 2 is a cross-sectional view taken along the line IV-IV in FIG. 1, the anode honeycomb current collector 10 together with the anode active material layer 30 compose the honeycomb anode of the battery which together with the solid electrolyte 22 define a plurality of channels 18 that are open-ended and extend from one end to the other of the honeycomb structure. The fluid cathode active material 12 fills the honeycomb channels 18. The outer walls of the anode honeycomb current collector 10 are left uncoated as shown and may serve as electrical contact points.

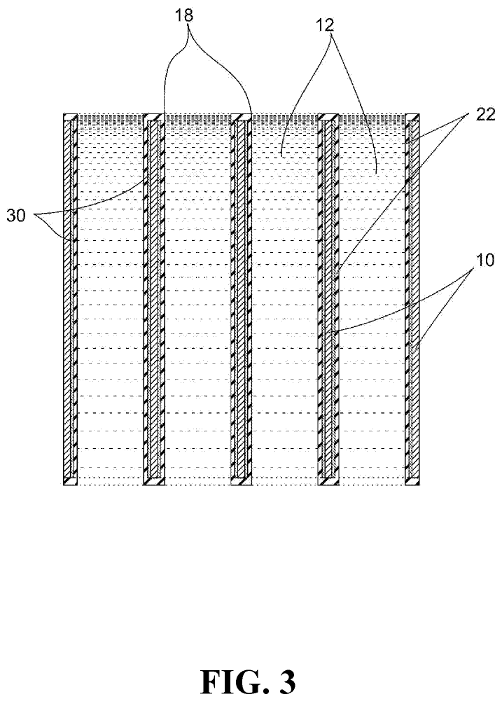

FIG. 3 is a cross-sectional view taken along the line VI-VI in FIG. 1, the anode honeycomb current collector 10 is integral and all its inner surfaces are coated with an anode active material layer 30 which is then coated by the solid electrolyte 22. The fluid cathode active material 12 fills the channels 18. FIG. 3 better illustrates the open-ended nature of the honeycomb channels 18 that run the length of the honeycomb structure.

FIG. 4 presents an elevational cross-sectional view of a practical embodiment of the present invention incorporating the honeycomb electrode secondary battery embodiment illustrated in FIG. 3. The embodiment of FIG. 4 comprises an anode honeycomb current collector 10 and an anode active material layer 30 that together compose the honeycomb anode of the battery. The embodiment also comprises an integral fluid cathode active material 12, and a solid electrolyte 22. The cathode current collector covers 14 together with the fluid cathode active material 12 compose the fluid cathode of the battery. The solid electrolyte 22 has ionic conductivity and insulates the honeycomb anode from the fluid cathode. The solid electrolyte 22 is provided as a coating on the channels 18 within the honeycomb anode. The bare outer walls of the anode honeycomb current collector 10 may be used as electrical contact points. The channels 18 within the honeycomb anode are open-ended and extend the length of the honeycomb structure. Gaskets 24 provide insulation and fluid seal between the cathode current collector covers 14 and the solid electrolyte 22 to contain the fluid cathode active material 12. The outer walls of the cathode current collector covers 14 may be used as electrical contact points. The honeycomb structure of the present secondary battery provides enhanced secondary battery performance by providing vast electrode surface areas for electrochemical reactions and allowing for the free flow of the fluid cathode active material 12 through the honeycomb structure for thermal management. The inlet 26 and outlet 28 may be used for an external pump to flow the fluid cathode active material 12 to move heat away from hot spots within the secondary battery to a radiator. The cathode current collector covers 14 may be used as radiators or an external radiator may be used.

Alternatively, the inlet 26 and outlet 28 may be sealed and thermal management, albeit reduced, may be achieved in a more passive manner such as fluid convection of the fluid cathode active material 12 to move heat away from hot spots within the secondary battery.

In the battery illustrated in FIG. 1, FIG. 2, FIG. 3, and FIG. 4, non-limiting examples of anode active material layer 30 materials are carbon materials such as graphene, graphite, amorphous carbon, and carbon nanotubes. In the case of graphene, chemical vapor deposition can be used to coat the channels of the anode honeycomb current collector 10 with an anode active material layer 30 composed of graphene.

As the anode honeycomb current collector 10, an electrode part formed of copper or copper alloy can be used and it may be extruded to create the honeycomb structure. Non-limiting examples of solid electrolyte 22 materials include garnet-like structure compounds such as (Li_{6.4}La₃Zr_{1.4}Ta_{0.6}O₁₂), LISICON compounds such as Li_{1.5}Al_{0.5}Ge_{1.5}(PO₄)₃, and ion conducting lithium based glass ceramics. As the fluid cathode active material 12 molten lithium metal, molten lithium alloy, molten sodium metal, or molten sodium metal may be used. As conductive covers 14, current collectors formed of aluminum or aluminum alloy can be used. As the gaskets 24, an electrically insulating gasket such as Teflon or silicone can be used.

Optionally, the fluid cathode active material 12 may be replaced by a more common solid cathode active material such as a lithium metal oxide, in which case the thermal management feature previously discussed is no longer possible and heat will only be dissipated by typical heat conduction.

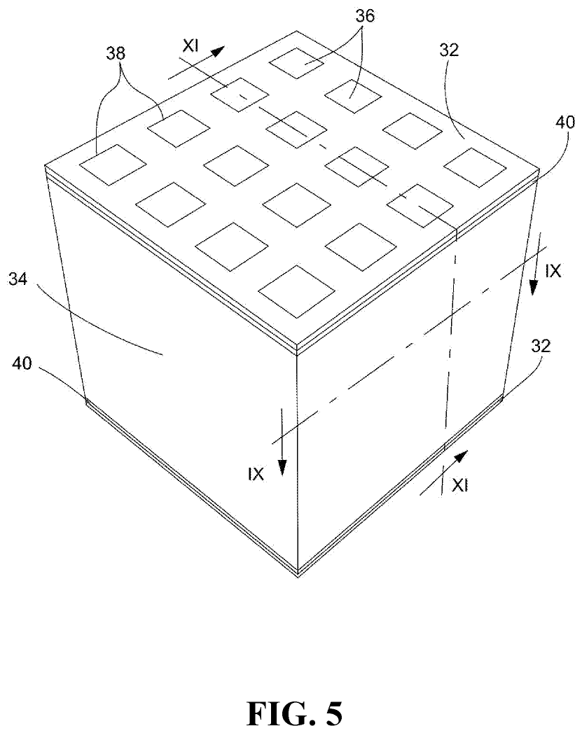

FIG. 5 is a perspective view of another non-limiting embodiment of the present honeycomb electrode secondary battery in lithium-oxygen form. The honeycomb anode 34 together with the solid electrolyte 40 and the cathode substrate layer 32 define a plurality of channels 38 that are open-ended and extend from one end to the other of the honeycomb structure. The fluid cathode active material 36 fills the channels 38 and is free to flow through the channels of the honeycomb structure for thermal management, fluid cathode active material 36 replenishment, and chemical byproduct purging. The fluid cathode active material 36 should not come into contact with the uncoated outer walls of the honeycomb anode 34 as damaging chemical reactions will take place, an additional chemically protective layer may be added to the outer uncoated walls of the honeycomb anode 34.

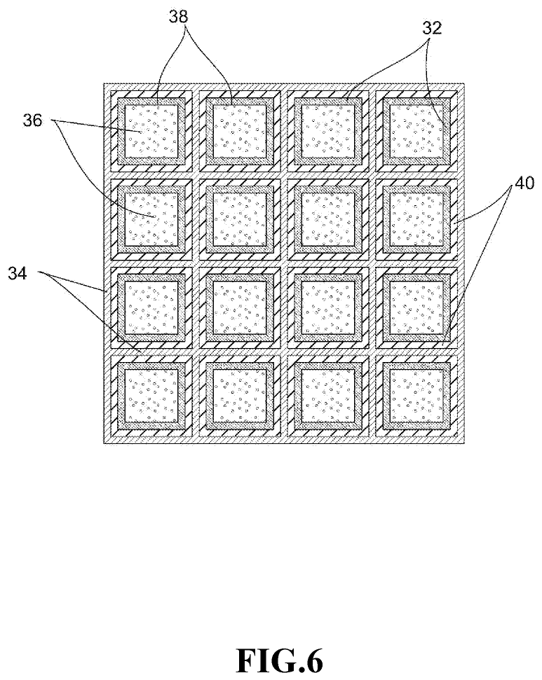

FIG. 6 is a cross-sectional view taken along the line IX-IX in FIG. 5, the honeycomb anode 34 together with the solid electrolyte 40 and the cathode substrate layer 32 define a plurality of channels 38 that are open-ended and extend from one end to the other of the honeycomb structure. The cathode substrate layer 32 together with the fluid cathode active material 36 compose the fluid cathode of the battery. The outer walls of the honeycomb anode 34 may serve as electrical contact points.

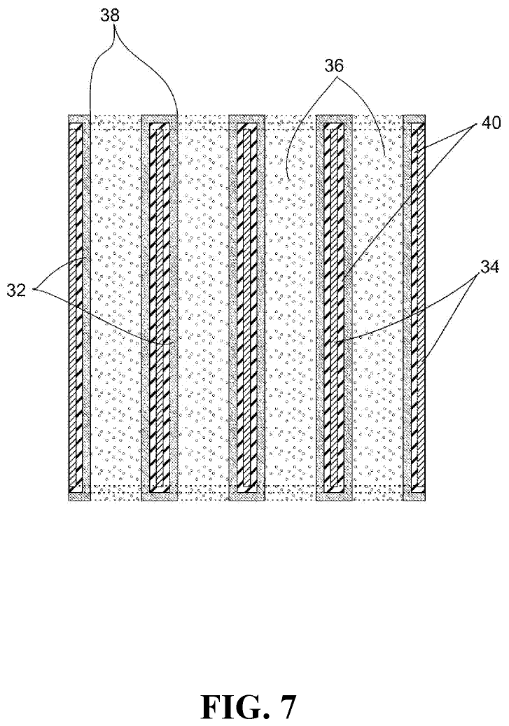

FIG. 7 is a cross-sectional view taken along the line XI-XI in FIG. 5. The honeycomb anode 34 is integral and all its inner surfaces are coated with the solid electrolyte 40 which is then coated by the cathode substrate layer 32. The cathode substrate layer 32 together with the fluid cathode active material 36 compose the fluid cathode of the battery. The cathode substrate layer 32 acts as the current collector for the fluid cathode of the battery. The solid electrolyte 40 has ionic conductivity and insulates the honeycomb anode 34 from the fluid cathode. The honeycomb anode 34 acts as the current collector for itself. The channels 38 within the honeycomb structure are open-ended and extend the length of the honeycomb structure. The honeycomb structure of the present secondary battery provides enhanced secondary battery performance by providing vast electrode surface areas for electrochemical reactions and allowing for the free flow of the fluid cathode active material 36 through the honeycomb structure for thermal management, fluid cathode active material 36 replenishment, and chemical byproduct purging. The flow of the fluid cathode active material 36 may be accomplished by an external fan, pump, or passively by fluid convection and molecular diffusion.

In the battery illustrated in FIG. 5, FIG. 6, and FIG. 7, a non-limiting example of a cathode substrate layer 32 material is a porous carbon with metal catalyst particles such as but not limited to manganese, cobalt, ruthenium, platinum, silver, or a cobalt-manganese mixture.

As the honeycomb anode 34, an electrode formed of lithium metal or lithium metal alloy may be used. The honeycomb anode may be extruded to create the honeycomb structure. Non-limiting examples of solid electrolyte 40 materials include garnet-like structure compounds such as (Li_{6.4}La₃Zr_{1.4}Ta_{0.6}O₁₂), LISICON compounds such as Li_{1.5}Al_{0.5}Ge_{1.5}(PO₄)₃, and ion conducting lithium based glass ceramics. As the fluid cathode active material 36, an oxygen rich fluid such as ambient air, pure oxygen, or water may be used.

Optional additional layers can be included to the different embodiments of the honeycomb electrode secondary battery of the present invention to optimize electrochemical performance, and/or chemical stability, and/or electrochemical material range capability, and/or current collection. These may be intercalation layers, and/or permeable separators, and/or current collectors, and/or wetting layers on the electrochemically active surfaces to provide a pristine contact interface. An example of a wetting layer is lithium metal alloy.

Multiple honeycomb electrode secondary batteries of the present invention may be electrically connected in series and/or parallel configurations to satisfy current and/or voltage requirements of specific applications.

It will be appreciated if numerous variations within the scope of the invention are contemplated.

What is claimed is:

1. A secondary battery comprising: a honeycomb first electrode; a fluid second electrode; and a solid electrolyte having ionic conductivity and insulating the honeycomb first electrode from the fluid second electrode, wherein the secondary battery has a honeycomb structure with a plurality of open-ended channels, and the fluid second electrode flows through the honeycomb structure.

2. The secondary battery in accordance to claim 1, wherein the honeycomb first electrode is a honeycomb anode comprising: an anode honeycomb current collector; and an anode active material, wherein the fluid second electrode is a fluid cathode comprising: a fluid cathode active material; and cathode current collector covers, wherein the cathode current collector covers contain the fluid cathode active material.

3. The secondary battery in accordance to claim 2, wherein the secondary battery is a lithium-ion secondary battery.

4. The secondary battery in accordance to claim 1, wherein the honeycomb first electrode is a honeycomb anode composed of an anode active material, wherein the fluid second electrode is a fluid cathode comprising: a cathode substrate layer; and a fluid cathode active material.

5. The secondary battery in accordance to claim 4, wherein the secondary battery is a lithium-oxygen battery.

6. A secondary battery comprising: a honeycomb first electrode; a solid second electrode; and a solid electrolyte having ionic conductivity and insulating the honeycomb first electrode from the fluid second electrode, wherein the secondary battery has a honeycomb structure with a plurality of open-ended channels.

7. The secondary battery in accordance to claim 6, wherein the honeycomb first electrode is a honeycomb anode comprising: an anode honeycomb current collector; and an anode active material, wherein the solid second electrode is a solid cathode comprising: a solid cathode active material; and cathode current collector covers, wherein the cathode current collector covers contain the solid cathode active material.

8. The secondary battery in accordance to claim 7, wherein the secondary battery is a lithium-ion secondary battery.
